(19) United States
(12) Patent Application Publication
(10) Pub. No.: US 2015/0314319 A1
(43) Pub. Date: Nov. 5, 2015

(54) FLUID APPLICATION DEVICE, SLOT DIE APPLICATOR AND GUIDE FORM FOR FLUID APPLICATION DEVICE

(71) Applicant: Illinois Tool Works Inc., Glenview, IL (US)

(72) Inventors: Jonathan David Cunningham, Hermitage, TN (US); Grant McGuffey, Springfield, TN (US)

(21) Appl. No.: 14/627,833

(22) Filed: Feb. 20, 2015

Related U.S. Application Data
(60) Provisional application No. 61/986,584, filed on Apr. 30, 2014.

(51) Int. Cl. B05C 5/02

(52) U.S. Cl. CPC B05C 5/0254

(57) ABSTRACT

A fluid application device for applying fluid to a strand of material, a slot die applicator and a guide form for the fluid application device are provided. The fluid application device includes an applicator head and a slot die applicator secured to the applicator head configured to discharge the fluid onto the strand of material. The slot die applicator includes the guide form. The guide form includes a guide slot configured to receive the strand of material. The guide slot includes a strand inlet, a strand outlet and a positioning section between the strand inlet and strand outlet. A transverse dimension of the positioning section decreases along a direction from the strand inlet to the strand outlet.

### BACKGROUND

The following description relates to a fluid application device, and in particular, a fluid application device having a slot die applicator and a guide form shaped and configured to position and guide a strand of material.

Nonwoven fabrics are engineering fabrics that provide specific functions such as absorbency, liquid repellence, resilience, stretch, softness, strength, flame retardant protection, easy cleaning, cushioning, filtering, use as a bacterial barrier and sterility. In combination with other materials, the nonwoven materials can provide a spectrum of products with diverse properties and can be used alone or as components of hygiene apparel, home furnishings, health care, engineering, industrial and consumer goods.

One or more elasticated strands may be positioned on and bonded to the nonwoven materials to, for example, allow for flexibility fitting around an object or a person. The strands may be bonded to the nonwoven fabric with an adhesive in the form of a glue fiber.

An adhesive application device may apply adhesive to the strands with a nozzle assembly, such as a die and shim extrusion assembly. As shown in FIGS. 1-3, the fluid application device may include a guide form or plate 10 secured to an applicator head of the fluid application device. The guide form 10 may serve as the die in a die and shim extrusion assembly. The guide form or plate 10 is configured to align the one or more strands 12 of material (FIG. 3) with respective openings or orifices formed in a shim (not shown) of the die and shim extrusion assembly through which the glue is discharged.

The guide form or plate 10 includes one or more guide slots 14 configured to position respective strands 12 of material relative to the orifices of the die and shim extrusion assembly. Each guide slot 14 includes an inlet side 16 configured to receive a respective strand 12 of material and an outlet side 18 through which the strand 12 of material exits the guide slot 14. The inlet side 16 and outlet side 18 are aligned along a direction of travel of the strand 12 of material. The guide slot 14 is typically square or rectangular in cross section in the direction of travel of the strand 12, and has a constant width ‘W1’, relative to the direction of travel of the strand 12 of material, between the inlet side 16 and outlet side 18. The guide slot 14 may further include an open side 20, between the inlet side 16 and outlet side 18, where the strand 12 of material may be initially received while the strand 12 of material is stationary.

Each strand 12 of material is fed from a respective strand supply. The strand 12 of material may be formed by multiple segments 12a, 12b of material tied together at adjacent ends. Accordingly, the length of the strand 12 of material may be increased to increase a run time of the fluid application device. That is, by increasing the length of the strand 12 of material, the fluid application device may be run continuously for a longer period of time before shutting down the device to replace the strand supply.

However, in the configuration above, a knot 22 in the strand 12 of material formed where adjacent segments 12a, 12b are tied to one another creates a portion of increased thickness along the strand 12 of material. If the strand 12 of material is off-center, or the knot is wider than the inlet side 16, the knot 22 may come into contact with the rectangular inlet side 16. This contact may cause the strand 12 to stretch or knot 22 to break, thereby separating the strand 12 of material. The fluid application device must then be shut down to repair and/or replace the strand 12 of material, resulting in production downtime.

Accordingly, it is desirable to provide a guide form for a fluid application device having a guide slot that is shaped and configured to accept knots of varying sizes along a strand of material and to properly position the strand of material as the strand is fed through the guide slot.

### SUMMARY

According to one aspect, there is provided a guide form for a fluid application device for positioning and guiding a strand of material. The guide form includes a guide slot configured to receive a strand of material. The guide slot includes a strand inlet, a strand outlet and a positioning section between the strand inlet and strand outlet. A transverse dimension, such as a width, of the positioning section decreases along a direction from the strand inlet to the strand outlet.

According to another aspect, there is provided a slot die applicator for a fluid application device for discharging a fluid onto a strand of material. The slot die applicator includes a guide form having a fluid inlet, an internal fluid conduit fluidically connected to the fluid inlet, and a cavity fluidically connected to the internal fluid conduit, a shim secured to and abutting the slot die applicator, the shim having a slit fluidically connected to the cavity of the guide form, and a cover plate secured to the shim. The guide form includes a guide slot configured to receive a strand of material, the guide slot having a strand inlet, a strand outlet and a positioning section between the strand inlet and strand outlet. A transverse dimension of the positioning section decreases along a direction from the strand inlet to the strand outlet.

According to still another aspect, there is provided a fluid application device for applying fluid onto a strand of material. The fluid application device includes an applicator head and a slot die applicator. The slot die applicator includes a guide form having a fluid inlet, and internal fluid conduit fluidically connected to the fluid inlet, and a cavity fluidically connected to the internal fluid conduit, a shim secured to and abutting the slot die applicator, the shim having a slit fluidically connected to the cavity of the guide form, and a cover plate secured to the shim. The guide form includes a guide slot configured to receive a strand of material, the guide slot having a strand inlet, a strand outlet and a positioning section between the strand inlet and strand outlet. A transverse dimension of the positioning section decreases along a direction from the strand inlet to the strand outlet.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a perspective view of a conventional guide form;

FIG. 2 is an enlarged view of a guide slot of the conventional guide form of FIG. 1;

FIG. 3 is a top perspective view of the conventional guide form of FIG. 1 including strands of material positioned in the guide slots;

FIG. 4 is a perspective view of a guide form according to one embodiment described herein;

FIG. 5 is an enlarged view of a guide slot of the guide form of FIG. 4;

FIG. 6 is another perspective view of the guide form of FIG. 4 including strands of material positioned in the guide slots;

FIG. 7 is a cross section of a slot die applicator including the guide form of FIG. 4, according to one embodiment;

FIG. 8 is a rear view of the slot die applicator of FIG. 7;

FIG. 9 is a rear perspective view of the slot die applicator of FIG. 7; and

FIG. 10 is a schematic diagram of a fluid application device including the slot die applicator of FIG. 7.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

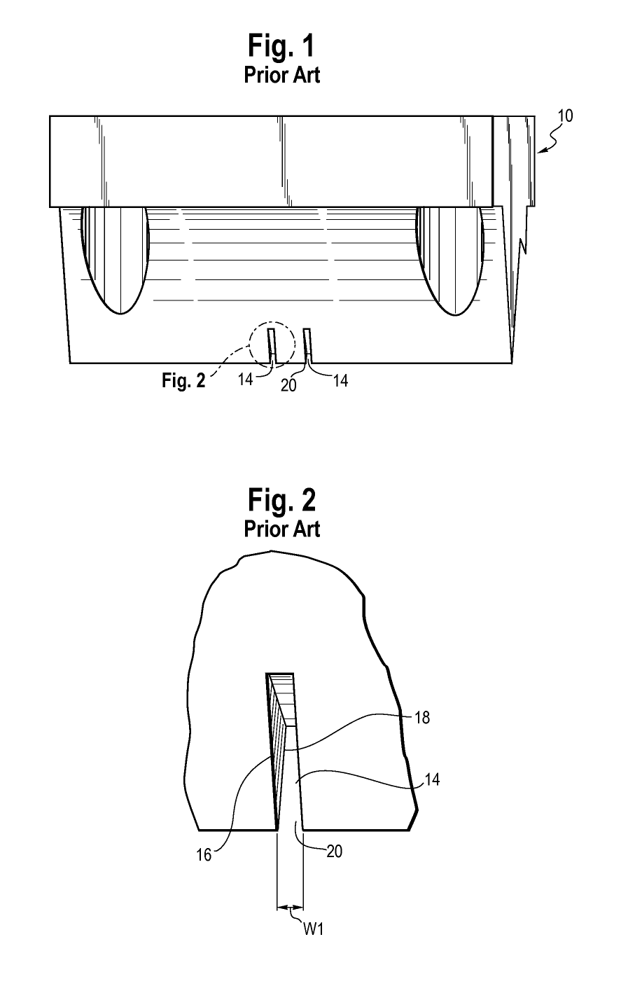

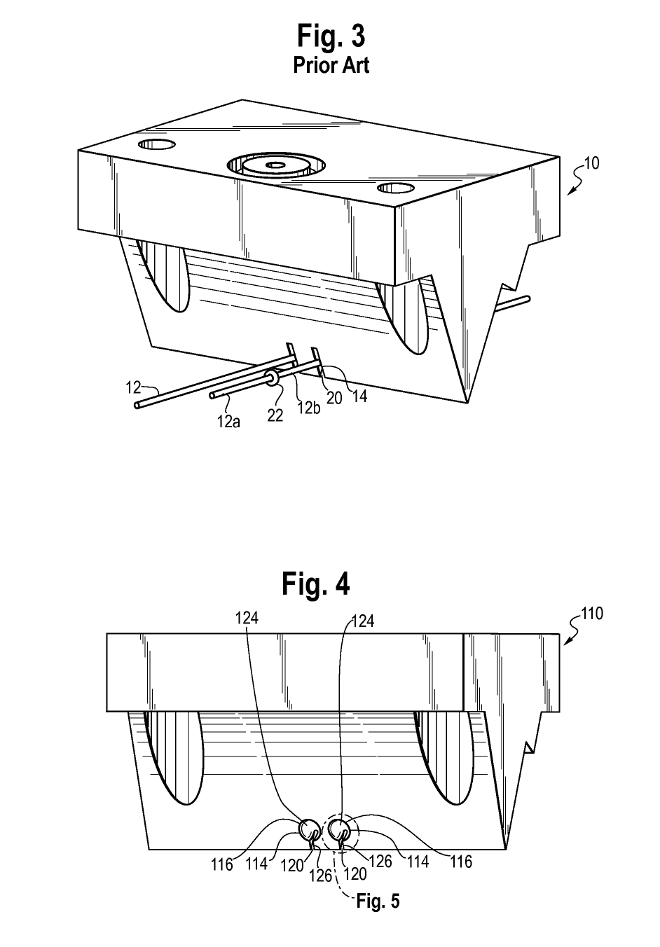

As detailed above, FIGS. 1-3 show various views of a conventional guide form 10 for a fluid application device. The conventional guide form 10 is configured to position strands 12 of material relative to a nozzle for application of an adhesive onto the strands of material 12. The conventional guide form 10 includes guide slots 14. In a direction of travel of the strands 12 of material during operation of the fluid application device, the guide slots 14 have a generally rectangular cross section having a constant width from the inlet side 16 to the outlet side 18. It is understood that “width” refers to the direction extending generally perpendicular to the direction of the travel of the strand 12 of material, as indicated by ‘W1’ in FIG. 2, and the constant width refers to the width ‘W1’ remaining constant along the direction of travel of the strand 12 of material between the inlet side 16 and outlet side 18. It is also understood that the conventional guide slots 14 are referred to as having a generally square or rectangular cross section, even though one side of the generally square or rectangular shape is open at the open side 20 of the guide slot 14.

FIGS. 4-6 illustrate an embodiment of a guide form 110 having a guide slot 114 in accordance with an embodiment described herein. FIG. 4 is a perspective view of one example of the guide form 110. The guide form 110, as noted above, includes one or more guide slots 114. Referring to the embodiment shown in FIG. 4, the guide form 110 may include two guide slots 114. However, it is understood that this example is non-limiting, and the guide form 110 may be manufactured to include varying numbers of guide slots 114 to accommodate varying numbers of strands 112 (see FIG. 6) of material for particular applications.

With further reference to FIG. 4, each guide slot 114 includes a positioning section 124. Each guide slot 114 may further include a neck 126, formed continuously with the positioning section 124, configured to receive a strand 112 of material during an initial set-up phase of a fluid application device 128 (see FIG. 10), i.e., when the strand 112 of material is stationary and not being fed from a supply.

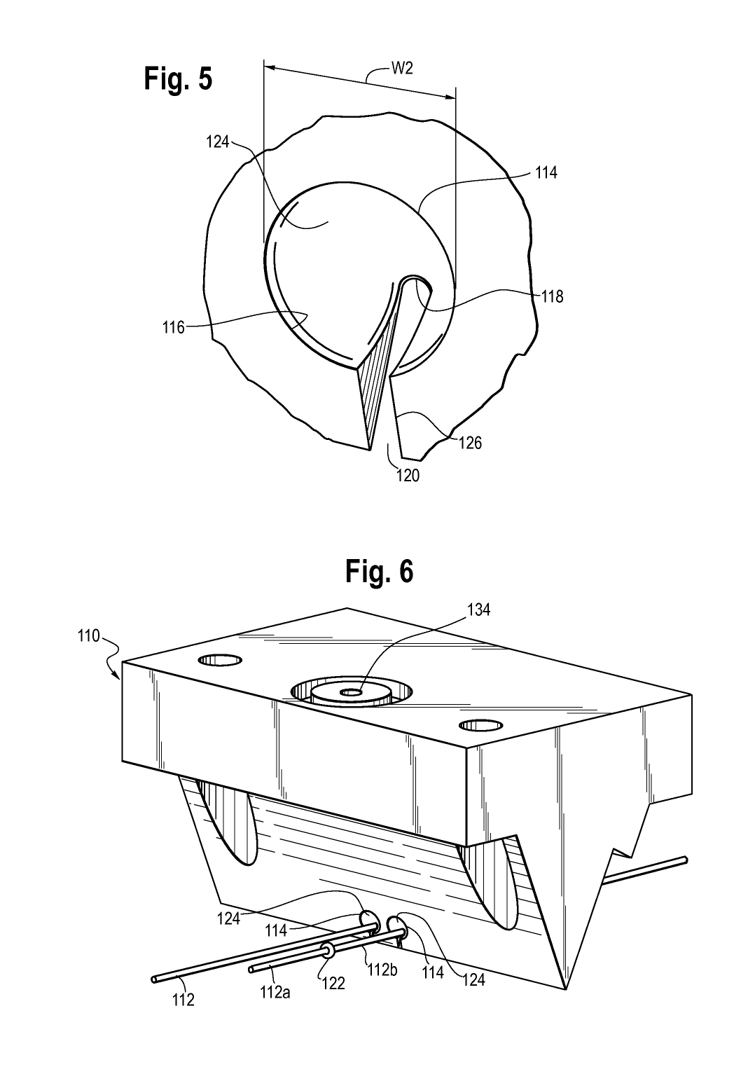

FIG. 5 is an enlarged view of a guide slot 114 of the guide form 110 according to one embodiment. Referring to FIG. 5, the guide slot 114 includes a strand inlet 116 and a strand outlet 118. The strand inlet 116, strand outlet 118, and positioning section 124 may be coaxially positioned. The positioning section 124 extends between the strand inlet 116 and strand outlet 118. A transverse dimension of the positioning section 124 varies between the strand inlet 116 and strand outlet 118. For example, the transverse dimension may be a width ‘W2’ of the positioning section 124 that decreases along a direction extending from the strand inlet 116 to the strand outlet 118. In one example, the width ‘W2’ of the positioning section 124 decreases along the common axis along which the strand inlet 116, strand outlet 118 and positioning section 124 may be positioned, from the strand inlet 116 to the strand outlet 118. The width ‘W2’ may decrease continuously along the length of the positioning section 124 between the strand inlet 116 and strand outlet 118. Accordingly, a width at the strand inlet 116 is greater than a width at the strand outlet 118.

The positioning section 124 may have a substantially circular cross section viewed along the direction extending from the strand inlet 116 to the strand outlet 118. Accordingly, the positioning section 124 may be formed in a substantially frustoconical or funnel shape. In such an example, the width ‘W2’ corresponds to the diameter of the positioning section 124 at a cross section at a point between the strand inlet 116 and strand outlet 118. In this example, the positioning section 124, strand inlet 116 and strand outlet 118 may be machined in a single pass with a standard center drill.

However, it is understood that the present disclosure is not limited to the configuration above. For example, the cross section of the positioning section 124 viewed along the direction extending from the strand inlet 116 to the strand outlet 118 may be formed or substantially formed in other shapes, such as, but not limited to, oval or polygonal shapes. It is understood that the terminology “substantially”, as used above with reference to the various shapes, includes both the actual shape and variations of the actual shape that function according to the principles described herein in the same manner as the actual shape.

With further reference to FIG. 5, the guide form 110 may further include the neck 126 formed continuously with the positioning section 124. The neck 126 extends from the positioning section 124 to an open side 120 through which the strand 112 of material may be initially received during a set-up phase of the fluid application device 128. In the description above, it is understood that a cross section of the positioning section 124 may be described as, for example, generally or substantially circular, oval or polygonal, or the positioning section 124 as a whole may be referred to as generally or substantially frustoconical, even though an opening to the neck 126 is formed in a portion of the periphery of the cross section or other shape.

FIG. 6 is another perspective view of the guide form 110 having strands 112 of material positioned in the guide slots 114. The strands 112 of material may be formed by individual segments 112a, 112b of material being tied or otherwise secured together to form a knot 122 or similar joint. In use, according to one example, a strand 112 of material may be initially received in the positioning section 124 during a set-up phase of the fluid application device 128 through the neck 126. Once disposed in the positioning section 124, the fluid application device 128 may be operated to feed the strand 112 of material in a direction from the strand inlet 116 to the strand outlet 118. The strand inlet 116 is sufficiently sized to receive the knot 122. In addition, the strand inlet 116 is sufficiently sized to receive the knot 122 and strand 112 in situations where the knot 122 and strand 112 are fed to the guide form 112 at a position eccentric to the guide slot 114. Upon introduction of the knot 122 through the strand inlet 116, the positioning section 124 may act as a guide to direct the knot 122 to the strand outlet 118. In addition, as the knot 122 is fed through the positioning section 124, the knot 122 may be stretched. Accordingly, more fluid (e.g., adhesive) may be applied to the knot 122.

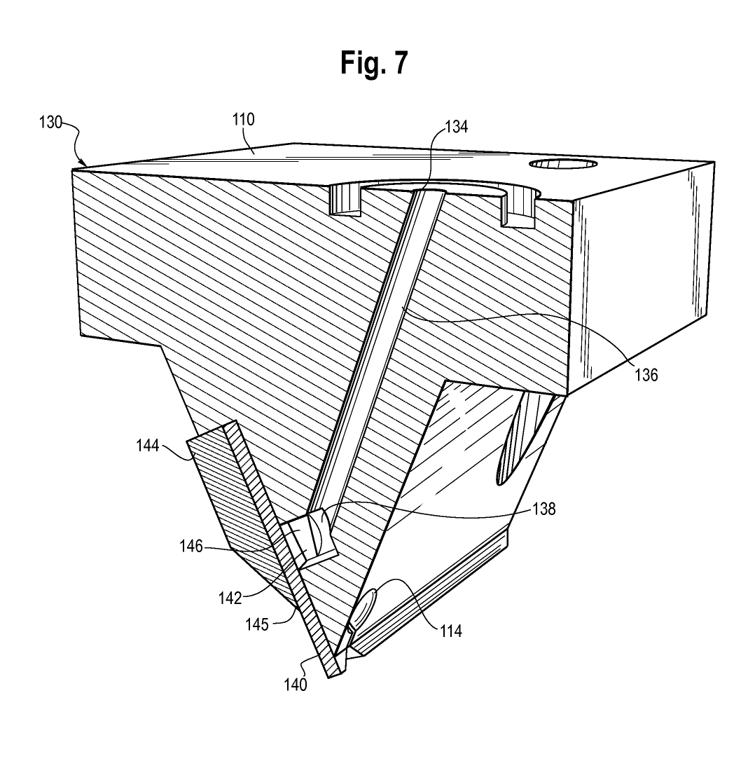

FIGS. 7-9 illustrate a slot die applicator 130, including the guide form 110, for the fluid application device 128. That is, the guide form 110 may be part of a slot die applicator 130. In one example, the guide form 110 may serve as the die in the slot die applicator 130 and may be used for slot die coating or extrusion coating applications. The slot die applicator 130 is configured to receive the fluid via an applicator head 132 of the fluid application device 128 and discharge the fluid through one of more orifices onto the one or more strands 112 of material.

FIG. 7 shows a cross section of the die slot applicator 130. Referring to FIGS. 6 and 7, the die slot applicator 130 includes a fluid inlet 134 in the guide form 110 configured to receive the fluid from the applicator head 132 or other component of the fluid application device 128. The guide form 110 further includes an internal fluid conduit 136 fluidically connected to, and configured to receive the fluid from, the fluid inlet 134. A cavity 138 is formed in the guide form 110 at an end of the fluid conduit 136 opposite of the fluid inlet 134. The cavity 138 is configured to receive the fluid from the fluid conduit 136.

The slot die applicator 130 further includes a shim 140 secured to the guide form 110. The shim 140 abuts the guide form 110. The shim 140 includes one or more slits 142 in fluid communication with the cavity 138. The one or more slits 142 are configured to receive the fluid from the cavity 138.

Still referring to FIG. 7, the slot die applicator 130 further includes a cover plate 144. The cover plate 144 is secured to the guide form 110 and abuts the shim 140. The cover plate 144 covers a portion of the slit 142 and forces the fluid in a direction to be discharged from the slit 142 for application on the strand 112 of material. One end 145 of the cover plate 144 may be formed either as an angular section or a rounded or convexly filleted section. In some embodiments, a rounded or convexly filleted end 145 may allow for improved strand performance by, for example, reducing stress applied on the strand 112 from the end 145 in the event the strand 112 is brought into contact with the end 145.

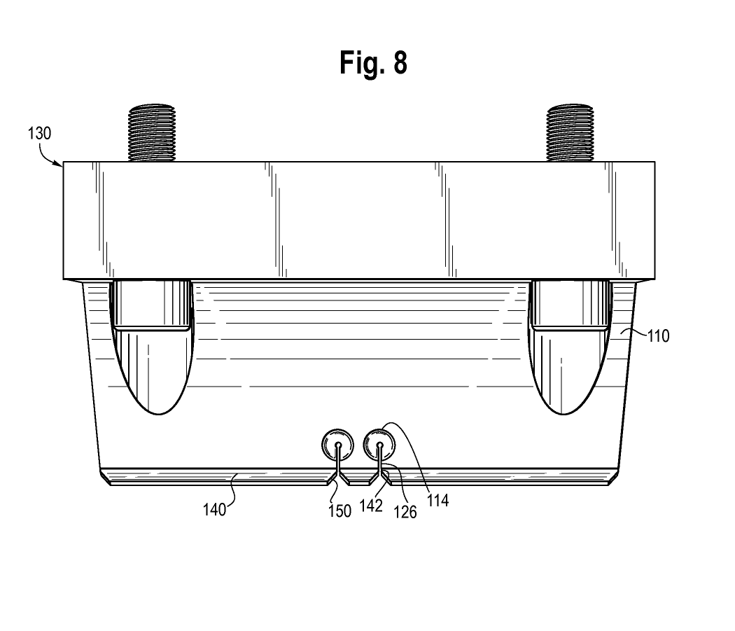

FIG. 8 is rear view of the slot die applicator 130. Referring to FIG. 8, it is shown that the number and position of the one or more slits 142 of the shim 140 may correspond to the number and position of the guide slots 114 and necks 126 of the guide form 110. That is, the shim 140 may include the same number of slits 142 as there are guide slots 114 in the guide form 110. In addition, each slit 142 is aligned with a corresponding guide slot 114 such that a strand 112 of material may be received in the guide slot 114 and the corresponding slit 142.

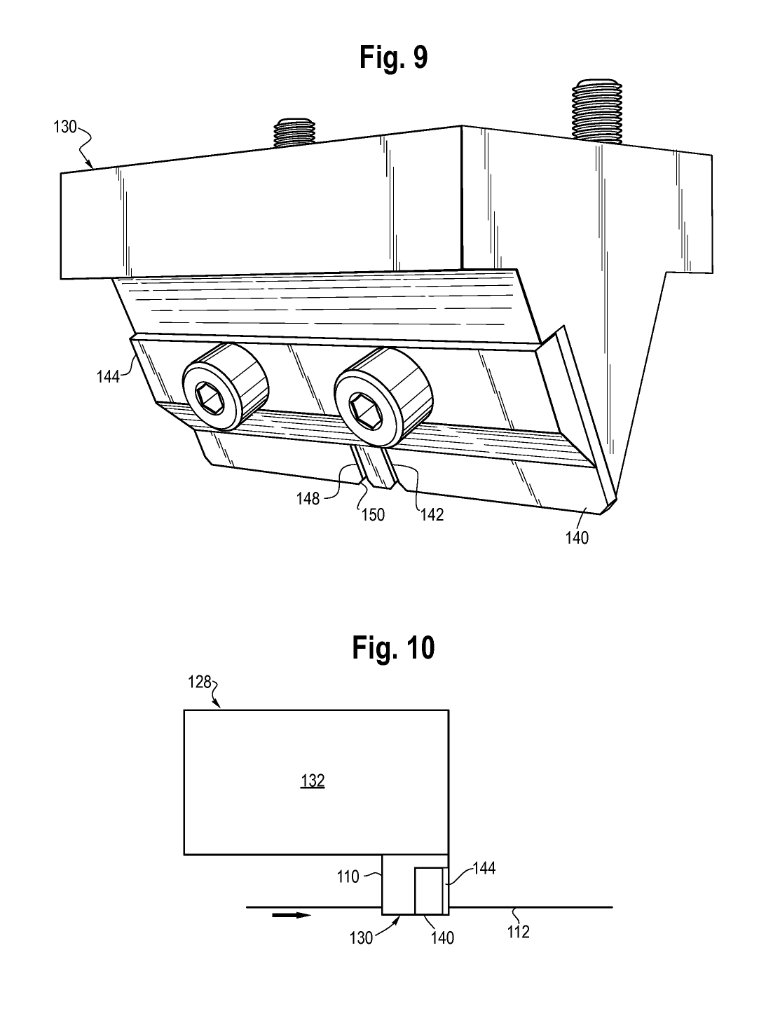

FIG. 9 is a rear perspective view of the slot die applicator 130. Referring to FIGS. 7-9, each slit 142 of the shim 140 includes a collecting portion 146 (see FIG. 7) configured to receive the fluid from the cavity 138, a strand receiving portion 148 (see FIG. 9) extending from the collecting portion 146 and a centering portion 150 (see FIGS. 7-9) at an end of the strand receiving portion 148 opposite from the collecting portion 146. The collecting portion 146 may be generally V-shaped, and the centering portion 150 may be a generally inverted V-shape. A discharge orifice, for discharge of the fluid, is formed in the slit 142 between the collecting portion 146 and centering portion 150 at an area bound by the cover plate 144 and the guide form 110, at the end point 145 of the cover plate 144.

FIG. 10 is a schematic diagram showing the fluid application device 128 including the guide form 110 and slot die applicator 130 described above. The fluid application device 128 includes the applicator head 132 having the slot die applicator 130 secured thereto. In one embodiment, the guide form 110 of the slot die applicator 130 is secured to the applicator head 132. The slot die applicator 130 is configured to discharge the fluid, such as a hot melt adhesive, on to the strand or strands 112 of material. The strand or strands 112 of material may be an elastic material, and may be fed through the guide form 110 in either a relaxed or stretched condition. In other examples, the slot die applicator 132 may be replaced with a contact or non-contact nozzle assembly separated from the guide form 110. In such an example, the guide form 110 may be positioned upstream from the nozzle assembly, such that the strand 112 of material is fed through the guide form 112 before reaching the nozzle assembly.

In the embodiments above, the guide slot 114 may be used to center a strand 112 of material and a knot 122 (or knots) formed along the strand 112 of material for proper positioning relative to the respective slits 142 of the shim 140, and in particular, the discharge orifices formed in the slits 142. The strand inlet 116 of the guide slot 114 is sufficiently sized so as to accept varying knot 122 sizes and account for eccentricities in the positioning of the strand 112 of material. The decreasing diameter or width of the positioning section 124 may serve to guide the knot 122 and strand 112 of material to the proper position over a length formed between the strand inlet 116 and strand outlet 118, and may thereby reducing an impact of the knot 122 with the guide slot 114. Accordingly, the knots 122 may more freely pass through the guide slot 114, be less susceptible to breaking, and in turn, reduce downtime of the fluid application device. Further, because the knot 122 may stretch through the positioning section 124, more adhesive may be applied to the knot 122, allowing the knot 122 to be secured to the substrate in a stretched or “flattened” position. As a result, the knot 122 may protrude a shorter distance from the substrate and may be more comfortable for a wearer of the end product.

It should also be understood that various changes and modifications to the presently disclosed embodiments will be apparent to those skilled in the art. Such changes and modifications can be made without departing from the spirit and scope of the present disclosure and without diminishing its intended advantages. It is therefore intended that such changes and modifications be covered by the appended claims.

1. A guide form for a fluid application device for positioning and guiding a strand of material, the guide form comprising:
a guide slot configured to receive a strand of material, the guide slot having a strand inlet, a strand outlet and a positioning section between the strand inlet and strand outlet, wherein a transverse dimension of the positioning section decreases along a direction from the strand inlet to the strand outlet.

2. The guide form of claim 1, wherein the diameter of the positioning section decreases continuously.

3. The guide form of claim 1, wherein the positioning section is substantially frustoconical.

4. The guide form of claim 1, wherein the positioning section is substantially polygonal in cross section.

5. The guide form of claim 1, further comprising a neck in communication with the positioning section, the neck having an open side.

6. The guide form of claim 1, wherein the transverse dimension is a width of the positioning section.

7. A slot die applicator for a fluid application device for discharging a fluid onto a strand of material, the slot die applicator comprising:
a guide form having a fluid inlet, an internal fluid conduit fluidically connected to the fluid inlet, and a cavity fluidically connected to the internal fluid conduit;
a shim secured to and abutting the slot die applicator, the shim having a slit fluidically connected to the cavity of the guide form; and
a cover plate secured to the shim,
wherein the guide form includes a guide slot configured to receive a strand of material, the guide slot having a strand inlet, a strand outlet and a positioning section between the strand inlet and strand outlet, and wherein a transverse dimension of the positioning section decreases along a direction from the strand inlet to the strand outlet.

8. The slot die applicator of claim 7, wherein the diameter of the positioning section decreases continuously.

9. The slot die applicator of claim 7, wherein the positioning section is substantially frustoconical.

10. The slot die applicator of claim 7, wherein the positioning section is substantially polygonal in cross section.

11. The slot die applicator of claim 7, further comprising a neck in communication with the positioning section, the neck having an open side.

12. The slot die applicator of claim 7, wherein the transverse dimension is a width of the positioning section.

13. A fluid application device for applying fluid onto a strand of material, the fluid application device comprising:
an applicator head; and
a slot die applicator comprising:
a guide form having a fluid inlet, and internal fluid conduit fluidically connected to the fluid inlet, and a cavity fluidically connected to the internal fluid conduit;
a shim secured to and abutting the slot die applicator, the shim having a slit fluidically connected to the cavity of the guide form; and
a cover plate secured to the shim,
wherein the guide form includes a guide slot configured to receive a strand of material, the guide slot having a strand inlet, a strand outlet and a positioning section between the strand inlet and strand outlet, and wherein a transverse dimension of the positioning section decreases along a direction from the strand inlet to the strand outlet.

14. The fluid application device of claim 13, wherein the diameter of the positioning section decreases continuously.

15. The fluid application device of claim 13, wherein the positioning section is substantially frustoconical.

16. The fluid application device of claim 13, wherein the positioning section is substantially polygonal in cross section.

17. The fluid application device of claim 13, further comprising a neck in communication with the positioning section, the neck having an open side.

18. The fluid application device of claim 13, wherein the transverse dimension is a width of the positioning section.
